(19) United States
(12) Patent Application Publication
(10) Pub. No.: US 2004/0137980 A1
(43) Pub. Date: Jul. 15, 2004

(54) User participation in event at computer network site

(76) Inventor: William M. Aenlle, Playa Del Rey, CA (US)

Correspondence Address: WILLIAM M. AENLLE, 6200 VISTA DEL MAR, 201, PLAYA DEL REY, CA, 90293, US

(21) Appl. No.: 10/339,240

(22) Filed: Jan. 10, 2003

(51) Int. Cl. A63F 13/00

(52) U.S. Cl. 463/17

(57) ABSTRACT

A tiered game scheme for incentivising users to visit web sites by participating in a free lottery game and subsequent video games at a sponsor's site. Participants as part of teams play a free remote lottery system without wagering any money or purchasing tickets. Participants of a team are issued individual numbers, which in combination comprise a lottery entry. Full or partially matching numbers receive a prize or eligibility to participate in secondary games of chance. In the event of not winning the lottery, eligible participants are invited to a sponsors web site to take part in secondary video games with improved chances of winning additional prizes. Participants must select and play one or more video games at the sponsor's site to entitled them to subsequent free lottery entries. At the sponsor's site, the game player is influenced by site offers for products/services.

The invention relates to a method of maintaining user participation in an event occurring periodically at a site on the computer network, for example a lottery.

Lotteries, both private and state operated, are popular games with many people. The simplicity and convenience of being able to purchase one or more lottery tickets for a state game, encourages many persons to play who might not otherwise gamble. Nonetheless, conventional lotteries have their drawbacks, which can be discouraging to some players.

Conventional state-run lotteries or casinos generally assign a set of numbers to an individual for a fixed fee. The game is played by picking generally six numbers of a selected set such as from 1 to 49. The numbers may be assigned randomly or the players may have the ability to choose numbers or sets of numbers, which are then printed on a lottery ticket. Once ticket sales have ended, winning numbers are selected randomly, either by computer or a mechanical device such as a hopper filled with numbered balls. The balls are mixed and pulled at random from the hopper to select the winning numbers and generally with long odds of winning on the game, no particular order of numbers is required. This activity provides the player a very brief interval of involvement. Should more than one player have chosen all or a predetermined part of the winning numbers, then the winning pool is shared by these players. If no one wins, the prize pool can accumulate (roll over), wholly or partly, thereby increasing interest in the lottery due to the increased potential prize.

A typical state-run lottery has numerous widely dispersed terminals. Communication between the terminals and the central processor is needed for recording and verifying transactions. Each user selects data, and each transaction is verified and recorded. The winning numbers for the lottery are chosen daily, weekly, etc., usually at a publicized event. Frequently, such lottery systems for each play entry require the user to mark a card with several selections (e.g., three to six selections) from a set of possible numbers which numbers are not repeated. By means of communication between a data entry terminal and a central computer, the player entry data is recorded and validated well before the winning number is selected, whereby it is not possible to alter a play entry record to cover a winning number. Furthermore, all data being centralized, the number of winners and the prize amounts, as well as the entry location, can be readily determined.

New Internet lotteries have appeared recently with the advent of the Internet which offer free lottery entries to consumers in exchange for visiting (clicking through) to sponsor's sites. The draws tend to be held daily and offer for example a $1 million jackpot—a possibility they insure against with a prize indemnity policy. These lotteries are administrated and managed in similar ways to the state run lotteries described above.

These Internet free lotteries are commercial (private) companies supported by advertising revenues. Internet users (consumers) are invited to the lottery sites to select their lottery numbers for a day's draw. The sites usually offer a number of options—the choice of selecting the user's own numbers, or the option of a “quick pick”, where the computer randomly selects the numbers for the user, and a facility to save/store these same numbers for future draws. In exchange for the free lottery entry, the participant must click on one of a plurality of advertising banners presented to validate the entry on the site's database. At a predetermined time of day an independent and verifiable draw is held to produce the winning number combination from the set of numbers. However, unlike most lottery games there is only one prize—the publicized jackpot. There are usually no intermediate or small prizes.

The disadvantage of these kinds of gaming rules stem from the fact that the chances of winning the jackpot prize is very small and with no chances to win other prizes in the draw—with no intermediate or small prizes to enhance the game. The players do not have much incentive to return after the novelty has worn off. Therefore, such games are not able to hold the attention of most potential participants for long while at the same time the winning chances are not satisfactorily good to attract more people to participate.

While State lotteries have been very successful, over the last decade the public's interest has decreased. Many states have turned to televising draws in an effort to generate additional interest in the lottery with varying results. The number selection shows, however, possess little excitement or suspense since they have relatively little spectator appeal.

A good majority of the people who participate in lotteries do not check their numbers on the day of the draw and pay little attention to the draw itself—checking their numbers a day or two later. It is understood that for most these people there is no excitement in actively following the results since the likelihood of winning is very small. But contrary to this state of mind, most play because someone always wins. A nominal dollar wager is accepted as fair price for the opportunity and fantasy of winning the jackpot.

In one known system set out in U.S. Pat. No. 5,628,684 assigned to La Francaise des Jeux, a card or ticket based system is described in which a user scratches off an obscured portion. If a win symbol is revealed the user inserts the card into a reader on a game console allowing the user to participate in games via the console with a central computer allowing further or enhanced winnings. This system, however, has various disadvantages. First of all it is paper based and involves the user both purchasing a ticket and accessing a games console. In addition the system is entirely dependent upon the user deciding to purchase a further ticket if he wishes to repeat his participation.

Accordingly a problem with known systems is that on completion of a first event user participation is terminated and repeat user participation can only be initiated upon re-registration, or re-entry by the user, in some cases prompted by repeat reminders issued by the site. As a result the site requires configuration for issuing reminders after the event in all instances except where the user instantly re-enters or re-registers, introducing a significant additional memory and processing burden at the site.

Known systems have specific disadvantages therefore. The very high odds in most lotteries (in particular free internet lotteries) leads to disillusionment in which case users may not participate repeatedly over any long period of time. Similarly the “all or nothing” typical system under which the user either wins a large jackpot or no prize at all is discouraging. Once again, therefore, the incentive to enter is mitigated by the low probability of a successful outcome. Generally speaking, the incentives to the user to participate, or continue to participate, are not high.

It is an object of the invention to overcome or mitigate disadvantages with known systems.

According to the invention there is provided a method of maintaining user participation in an event occurring periodically at a site on a computer network, in which a user registers at the site to participate in a first tier event having a user successful or a user unsuccessful outcome, which on a user unsuccessful outcome the user is automatically entered for participation in the next tier event, and on a user successful outcome an automatic invitation is issued from the site for the user to participate in a second tier event.

As a result user participation is maintained without the need for repeated reminders being issued from the site. At the same time user support and participation is enhanced.

Embodiments of the inventions will now be described, by way of example, with reference of the drawings, of which:

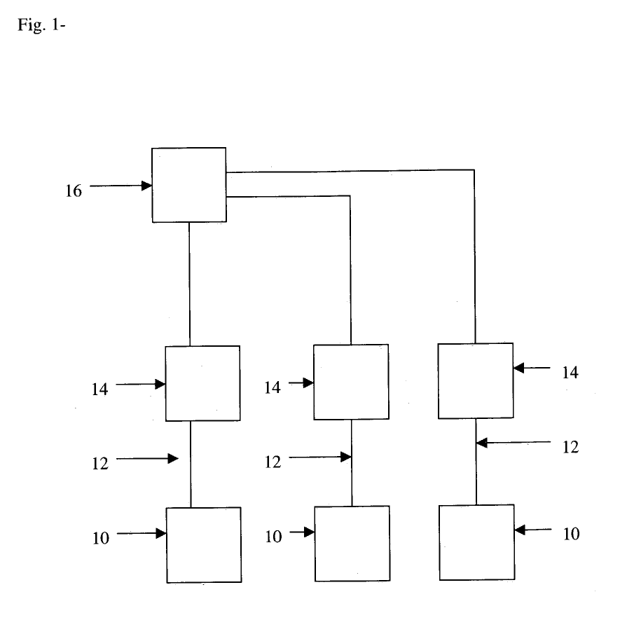

FIG. 1 is a block diagram showing a typical computer network for support in the present invention;

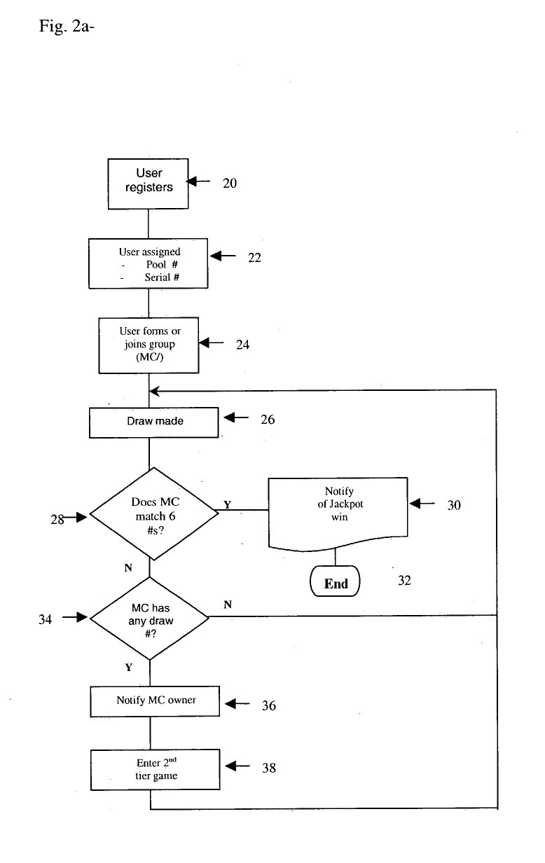

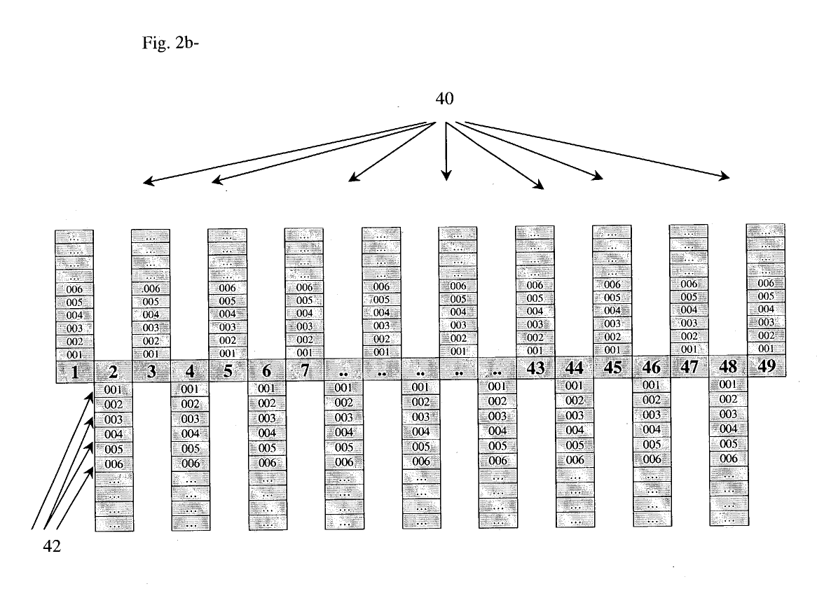

FIG. 2a is a flow diagram showing operation of the present invention;

FIG. 2b shows pool membership according to the present invention;

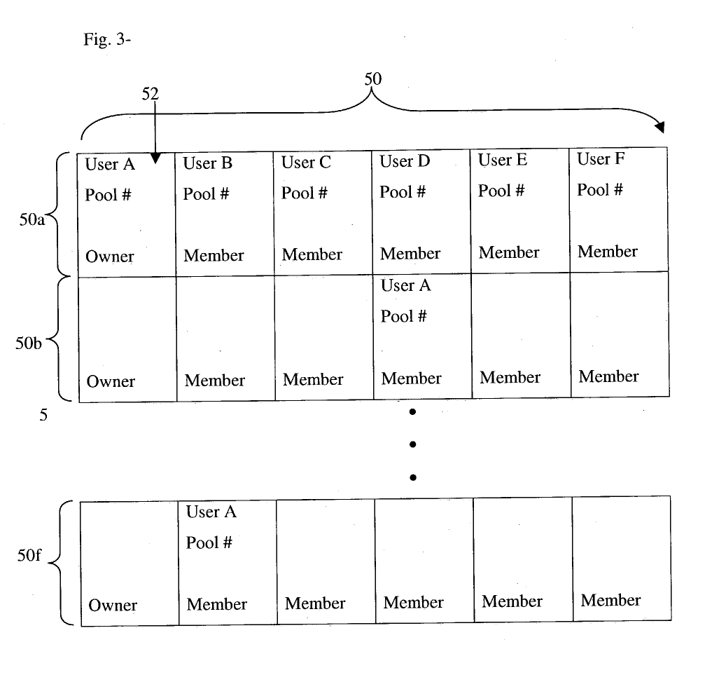

FIG. 3 is a further representation of pool membership according to the present invention;

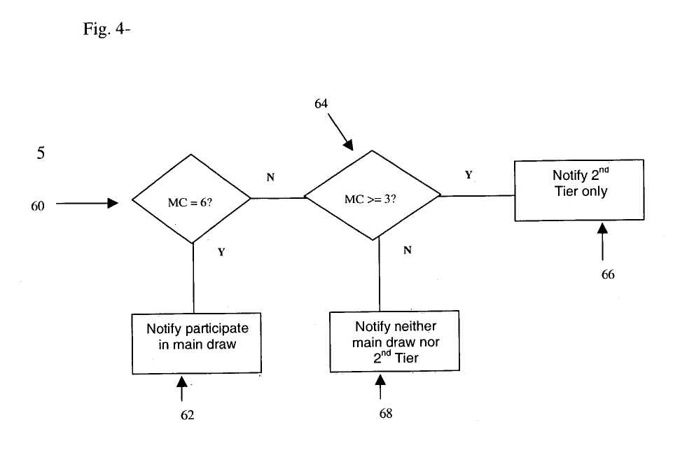

FIG. 4 shows operation of the present invention when there are less than six members;

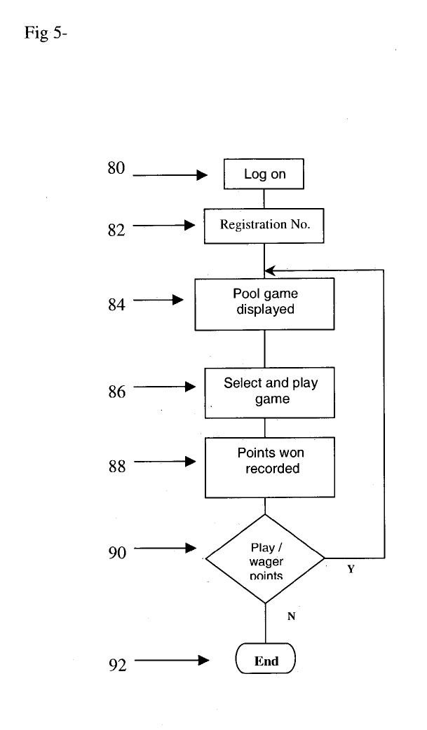

FIG. 5 is a flow diagram showing second tier participation;

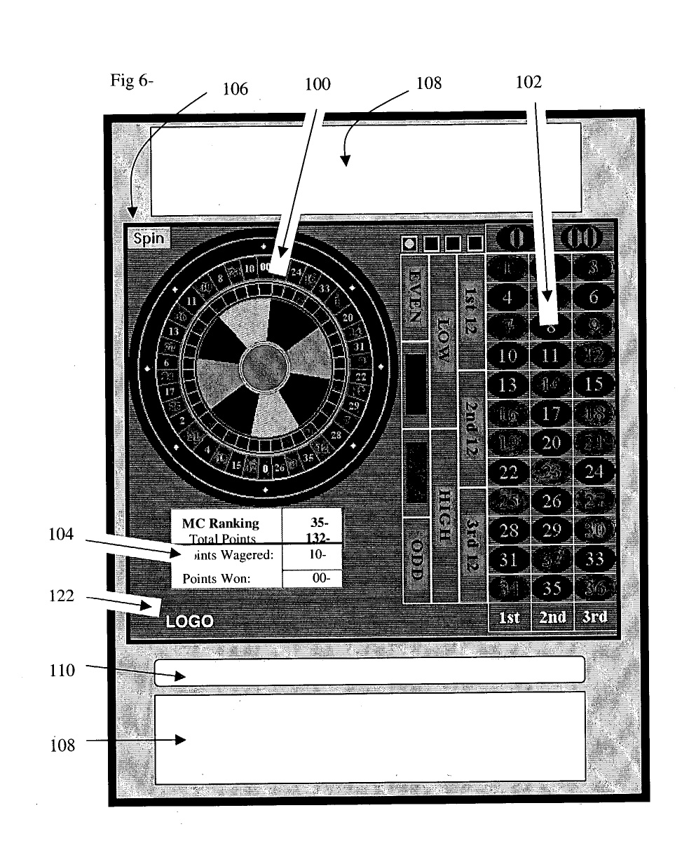

FIG. 6 is a representation of a roulette-based second tier game; and

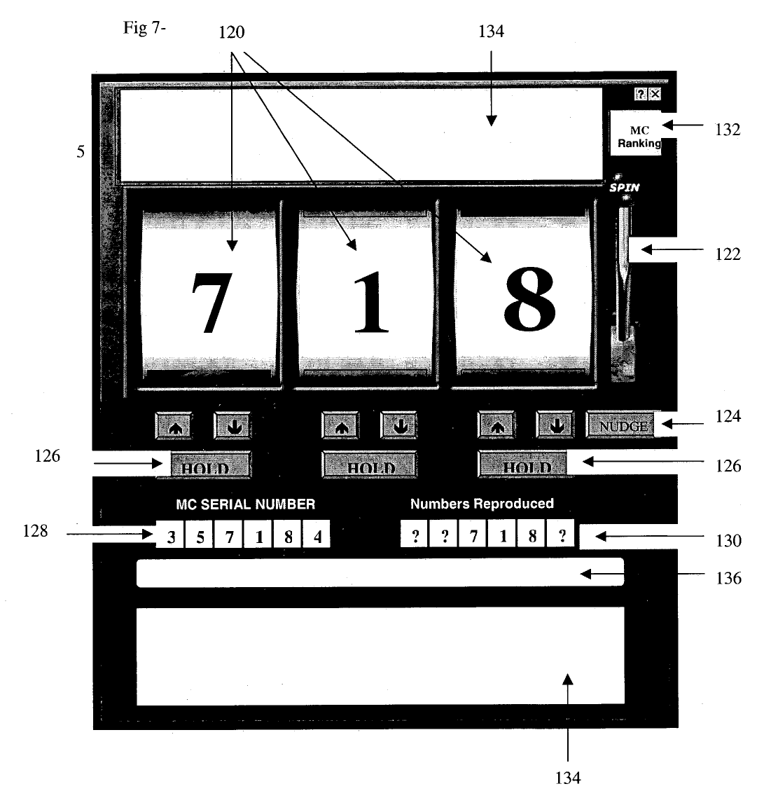

FIG. 7 is a representation of a slot-machine second tier game.

Referring to FIG. 1 typical computer network representing the type of system in which the present invention can be operated is shown. One particular type of network that would be appropriate, for example, is the Internet. A plurality of user nodes or terminals 10 are provided which can, for example, be a user's PC at home. The physical location of the terminals is limited only by the physical extent of the network such that the terminals, for example, could be in different countries or even different continents. The terminals 10 are connected to one another and the remainder of the computer network via known communication lines such as telephone lines, wireless communication means or fibre optic cables 12. The lines 12 can be connected by a network of intermediate servers or nodes 14 which, inter alia, provide a communication path to a host server 16 on which the site hosting an event is supported. It will be apparent to the skilled person that FIG. 1 is enormously simplified and that the interconnection of host and intermediate servers, and terminals can be provided in an almost infinite number of variations.

Discussion of the specific embodiments will be particularly directed to event-based systems based on games of skill and chance, for example a lottery draw, as a first tier event, allowing participation in a range of second tier events such as roulette games, slot machine games and so forth as discussed in more detail below. However it is contemplated that alternative types of event that require repeat user participation can also form the basis of the system.

FIGS. 2a and 2b provide an overview of the present invention from the point of view of a single user. Referring to FIG. 2a at step 20 the user registers by accessing the site at which the event takes place, for example the web site. At step 22 the user is assigned (or can select) a pool number with a corresponding pool serial number. The serial number is assigned specific to the pool user falls in, is assigned sequentially. If the user changes pool a new serial number issues. Assuming a lottery based on six draws of numbers between one and forty nine, the pool numbers similarly range from one to forty nine and can therefore also be viewed as the user's draw number, such that if the pool number is drawn in the lottery draw then all the users in the pool having the corresponding number will be eligible for the second tier as discussed in more detail below. The serial number assigned is unique to each user and is principally used for identification purposes. FIG. 2b shows allotment of pool numbers in more detail. For each lottery number 1 to 49 a separate pool 40 is set up. Each pool includes a number of users, each user being assigned a unique, sequential, numerical serial number. In the embodiment shown three digit serial numbers are shown but this is purely for convenience of representation—for example six digit serial numbers may be assigned

Reverting to FIG. 2a, at step 24 the user forms or joins a group of users termed a “micro-community (MC)”. Up to six players can join a micro-community, no two players from the same pool being allowed in a common micro-community. As a result each micro-community represents a selection of six numbers between one and forty-nine which can be matched against the numbers drawn in the lottery itself. Each of the six numbers effectively “belongs” to a respective user who had been assigned that number as a pool number. For the time being it is assumed that a micro-community of six members is formed—the steps that are taken if less than six numbers are in the group are discussed in more detail below. It will be noted that micro-communities could indeed form more than six players whilst retaining the lottery draw at six numbers. This would increase the chances of winning the jackpot and hence enhance user interest yet further. In one embodiment, for example, eight people could be members of the micro-community against a lottery draw of six numbers, thus increasing the chances of winning but dividing the winnings amongst more players.

At step 26 the lottery draw is made and the micro-community set of numbers is compared with the drawn numbers at step 28. If all six numbers match then at step 30 the micro-community is notified for example by email, of a jackpot win and the process ends at step 32. Otherwise at step 34 the micro-community is checked to see if any of the drawn numbers are found in it—if so then the micro-community holding that number is notified at step 36, preferably by email, and can participate in the second tier games, for example one or more video or casino games. This is one possible default allowing entry into the second tier games, of course, more than one number would be required or indeed second tier participation might be allowed only for micro-communities having none of their numbers drawn. The members of the micro-community participate in the second tier games at step 38. Exemplary games are discussed in more detail below.

In the present embodiment, if at step 34 no draw numbers are found in the micro-community then the micro-community is automatically re-entered for the next draw at step 26. In addition, on completion of the second tier games the micro-community is automatically re-entered for the next draw (the first tier) and it effectively returns to step 26. The system is most preferably used in the context of a promotions internet web site with banner advertising and/or supported by commercial sponsors. The first and second tier games are introduced as an incentive to visit the web site, and maintain continued visits to the web site, in particular because of the greater prospects of a win. As discussed in more detail below, in addition to the possibility of winning the jackpot in the first tier game, there are lesser prizes to be won, as well as the prospect of the entertainment of participating, in the second tier games. As a result repeat use is more likely to occur, not least because of the realistic prospect of winning a prize with no outlay. Because the micro-community is automatically re-entered into the first tier game in the event that none of the micro-community numbers are drawn, it is not necessary to issue continued reminders or requests for the users to re-enter each time the first tier game is carried out. Yet further, because of the provision of micro-communities, a team spirit is engendered as well as, as discussed in more detail, the odds of success being enhanced.

The system has yet further advantages that users are only contacted when they have either won the jackpot or when they are invited to enter the second tier games, again rendering the system more attractive than when repeated reminders are received simply to re-enter. Preferably, if the user enters the second tier game, they are automatically re-entered for the first tier game as well, increasing the prospects of winning over the long term. At the same time, each time the user enters a second tier game they are once again exposed to the promotional material effectively underwriting the system.

Micro-communities are discussed in more detail with reference to FIG. 3. A micro-community generally designated 50 is formed from six cells 52 each representing one user pool number. As a result the micro-community 50 comprises six numbers, which can be compared with the six numbers drawn from the lottery. There are two possible ways of entering a micro-community. The first of those is that a user, having been assigned a pool number and a serial number, then seeks five further users (or potential users) to join his or her micro-community. The second possibility is that the user is an invitee, registers with the system and requests entry into the relevant micro-community.

The person compiling the micro-community is termed the owner—the remainder, are termed members. As demonstrated in FIG. 3, a single user can be involved in more than one micro-community. For example where user A is owner of a first micro-community 50a together with users B to F, he can also be a member of up to five further micro-communities 50b to 50f. Each user is assigned an arbitrary limit of one ownership and five memberships.

In a preferred embodiment the treatment of micro-community owners and members differs somewhat. In particular, the micro-community owner receives fifty per cent of all prize money, with the remaining fifty per cent being shared equally amongst the other five members. In addition, when a lottery draw number matches one of the numbers is the micro-community, the micro-community owner is notified, for example by email. The onus is then on the micro-community owner to notify the remainder of the micro-community to participate in the second tier games; thereby reducing the number of emails to issue.

It is possible that a micro-community can be formed with less than six members as shown in FIG. 4. Accordingly an additional check routine can be added into the flow chart of FIG. 2a. At step 60 the number of users in the micro-community is checked. If there are six members then the micro-community is forwarded to participate in the main draw at step 62. If however there are less than six members then at step 64, if there are three or more members then they are notified that they are eligible but only for the second tier games (that is, if one of the less than six micro-community numbers comes up in the lottery draw) at step 66. Otherwise, at step 68 the micro-community is notified that they are eligible neither for the first nor the second tier. The micro-community and multiple entry systems allow much-improved odds in the system, increasing the incentive for users. In effect, each user has up to six opportunities to participate in the first tier game based on a single registration, that is, by being owner of one micro-community and member of five others. It will be appreciated that throughout this discussion, the embodiment is based on a lottery having numbers from one to forty nine, and six numbers drawn—any other permutations can of course be used, with resizing of the micro-communities as appropriate.

Based on the present embodiment, however, the odds of winning the jackpot are 13,983,816 to 1. However the odds of being entered for the second tier games are considerably better. For a micro-community owner, the odds of participating in a second tier are 6 out of 49 (six numbers in the micro-community of which the user is owner out of forty nine possible numbers) or roughly one in eight. If the lottery is drawn weekly then the micro-community owner is likely to participate in a contest roughly once every other month.

It will be appreciated that each of the six numbers drawn in the lottery represents a pool and as in the second tier there will be one micro-community winner for each pool then the odds of winning at the second tier games are much improved since these are linked to the number of participants in each pool. For example where 500,000 users take part in the entire system, there are roughly 10,000 participates per pool giving the micro-community owner odds of 1 in 10,000 of winning.

The odds of being entered for the second tier games are even shorter for a micro-community member assuming that that member is involved in the maximum five pools as a member with no repeat numbers. In that case the odds of participating are 30 to 49 or 1 in 1.6, roughly once every other week. However, the odds of winning the second tier game remain the same as the member wins as part of their micro-community, that is, 1 in 10,000.

It will be noted that a user can participate both as owner and member in the same draw, improving the odds yet further. Membership in the maximum number of micro-communities offers the highest prospect of winning the jackpot and participating in the most pool games. The prospects of winning the first tier jackpot are of course increased if each micro-community comprises a different range of numbers and it is also possible that a member, by virtue of membership of different micro-communities, will have more than one opportunity to participate in the second tier games. Furthermore a user can control frequency of participation in second tier games from a maximum of once every other week to as little as once every five weeks by selecting the maximum numbers of possible repeat numbers on all micro-community memberships. In the embodiment shown in FIG. 2, if the micro-community wins the jackpot then their participation ends but alternatively they could also be entered for the second tier games six times, as all six numbers had come up.

An overview of the second tier games is shown in FIG. 5. It will be noted that specific examples only of second tier games are presented here and that any appropriate second tier games can be contemplated; their basic purpose is to provide a more entertaining and exciting approach to games most people get easily bored with and thus maintain interest in the game system generally, as well as pay out to a winning micro-community.

As discussed above, in the first instance the micro-community owner is notified that the number their micro-community was drawn in the first tier draw. This is preferably by email formatted such that the micro-community owner can forward the email to the remaining members of the micro-community with a single click. Preferably micro-community owners have two days to notify micro-community members of the second tier game and four days in which to complete the games although this will be determined by the frequency of the first tier draw. In order to remove from the system people who abuse it, owners must participate every time their number comes up for the second tier whilst members must participate in two out of every three opportunities to enter the second tier, or they are not re-entered for the first tier game. Again these are only exemplary figures, but ensure that the system remains open to those who intend to use it and does not simply permit people to maintain a free-running entry for the main lottery draw. Furthermore, prize money is awarded on identity verification—where an individual cannot corroborate his identity or found to be playing under various aliases, their whole micro community will forgo their winnings. It is therefore self-promoting, self-realising and self-regulating. In addition a blacklist can be maintained if required.

The second tier games can be thought of as pool games, one specific game being assigned to each of the six pool numbers that were drawn in the lottery draw. Each pool game can be played by every micro-community which entered the second tier games and which has that pool number as one of its numbers. A fixed amount of prize money (equivalent for each pool game) is won by one of the micro-communities. This can be done, for example, by making each pool game points based, the winning micro-community being the community which obtains the most points in playing the game. Appropriate tie-breakers can be selected, for example one or more high card/low card draws between micro-community owners in tied micro-communities. It will be seen, therefore, that a micro-community may be entered for one or more of the pool games dependent on how many numbers in the micro-community were drawn in the lottery draw.

It will also be appreciated that each pool game comprises a separate competition although the same game type may be played for each pool number. In other words each of the six pool games may in fact comprise roulette, as discussed in more detail below, but with different numbers coming up, and different winners, for each of the six games of roulette. Alternatively an entirely different game type may be played for each pool, or any variation or combination between these extremes. Furthermore, as discussed below, a selection of games can be offered to the user for each pool. In the event that a winning micro-community has less than six members (which is possible in the embodiment as shown in FIG. 4) the unassigned prize money can be allotted to a charity chosen by the micro-community. Alternatively, irrespective of the size of the micro-community, the micro-community owner receives fifty per cent of the allocated winnings, the remainder of the allocated winnings being shared amongst the other members.

The pool games are preferably games of chance and in particular preferably casino games modified to enable users to influence their outcome. The games may comprise lottery draws, slot machines/fruit machines/one-arm bandits and dice-based games. In one embodiment the user's objective is to generate a specific series of numbers that make up their micro-community owner's serial number (as allotted when assigned to a pool). This may not be appropriate for all games, however; for example where roulette is the pool game, the micro-community chooses a number and bets with existing points. Dependent on the game, different numbers of points can be allotted dependent on the relevant odds, and participants may wager their accumulated points to increase their winnings. Where the game is based on the micro-community owner's serial number, if that number is not generated then the games points can be assigned to the micro-community whose number was produced. As a result each micro-community has the possibility of being awarded points based on the activities of another micro-community.

Referring now to FIG. 5 in more detail, the player first logs on at step 80 and the target number to be played for, for example the user's registration number is identified at step 82. The pool game details are then displayed at step 84. In one preferred embodiment, the player can select from a number of games offered for each pool, allowing a player to increase his or her prospects of accumulating points by selecting a game he is particularly familiar with or skilled at, or at the appropriate odds level for the player's preferred risk strategy. At step 86 the game is selected and played and the points won are recorded at step 88. At step 90 the player is offered the opportunity to play again and/or wager the existing points and if the player accepts then the process returns to step 84, where the selection of games is displayed. Otherwise the game terminates at step 92, the micro-community accumulated points are stored and compared against the remaining micro-communities' points in that pool game once the pool game is finished. As discussed above, the highest points winner wins the pool prize. All micro-communities participate in the second tier games, whether they win or lose, are automatically re-entered for the next first tier lottery draws.

Table 1 below shows an example of how points may be allotted according to a selection of pool games including a lucky dip, a lottery draw, slot machines, roulette and dice.

TABLE 1

| | | Freely | |
|---|---|---|---|
| Game of | Participating | participating | Winning |
| Chance | Friends & Family | players | points |
| Lucky Dip | 6 | 3 | 10 |
| Lottery Draw | 6 | 3 | 10 |
| Slots | 6 | 3 | 20 |
| Roulette | 6 | 3 | 20 |
| Dice | 6 | 3 | 30 |

It will be noted that the player can be a single member of an eligible micro-community or can be a representative of the entire micro-community in conference, sharing the play action. Preferably each number of the MC plays, maximising exposure to the site and increasing the prospects of accumulating the most points for the MC Running totals can keep the players informed of their progress. The winning micro-communities are informed, for example, by email, and as with the main prize, winners can be posted at the site. The points can be allotted in a more sophisticated manner than that shown in Table 1. For example higher points can be awarded when the micro-community consists of new users recruited to the system as opposed to existing users of the system. It will be noted in Table 1 that higher points are awarded to full micro-communities.

As mentioned above, and as will be apparent to the skilled reader, a very wide variety of games can be used including casino games or modified casino games, games of skill, board games, video arcade games, or alternatively puzzles. In addition any combination of the above games can also be used. Two embodiments comprising the best mode of the invention as currently contemplated by the inventor are now discussed.

Referring to FIG. 6 a video roulette game can be one of the games to be played, the rules and wagering being the same or similar to conventional casino games—however, the wagering currency being points instead of money, points being assigned equally to each micro-community (MC) at the outset. The representation preferably corresponds to a standard roulette arrangement including a wheel 100 and table 102. A points tally 104 is shown as well as advertising banners 108, a message field for messages from the central computer 110 and a logo, for example of the company hosting the site, 112. The placing of bets is carried out simply by clicking on the relevant number or fields of the table 102 and the wheel can be spun by clicking on icon 106. An alternative may be roulette with 49 numbers instead of the standard 38.

As represented by FIG. 7 the familiar slot machine game found in casinos can be used alternatively or in addition, but with modified rules such that unlike most casino games where the objective is to match pre-set winning conditions three indicia of a kind, three bars, or three 7s, etc.—the objective in this game is to reproduce a sequence of numbers (digits) that represent the serial number of a MC—for example that of the MC owner.

The game is in effect controlled by player made choices with respect to selecting numbers that make up the aforementioned MC registration number.

The preferred embodiment of the slot machine has three reels 120, with the indicia on these preferably numeric—single digits from 0 to 9 which may either be sequentially or randomly placed on the reel. Operation of the game is simply achieved by clicking in the conventional manner. The game may be started by depressing a button or pulling from a priming arm 122, the spin coming to a stop of its own accord. The user is given, for example, nudges 124 of the reels which may be up or down and a “hold” option 126. The nudges are applied as the player sees fit, all on one reel or otherwise. Three spin cycles are allowed for each game excluding any bonus spin/s awarded during play.

The game is started by spinning the reels in unison—players then wait for these to stop. Players are given various options on how to produce/select their desired numbers, for example select any of the outcome numbers to complete the serial number (bearing in mind that the serial number preferably has more digits than the number of reels) and nudge the remaining number/s to produce other desirable numbers; nudge one or all the outcome numbers into a bonus winning sequence thus producing three numbers to be allocated towards the serial number plus having an additional spin (as detailed below); or have the option to hold a reel number while spinning the remainder. On completion of the available spins the player will either have successfully re-produced the stipulated serial number displayed at 128 for which full points are awarded, or in the event that the serial number is not completed as shown at 130, the outstanding numbers will be randomly filled-in (completed) by the game and the game's points awarded to the corresponding MC.

A bonus win situation—reproducing any set of three consecutive numbers with respect to the serial number will award a bonus, for example an additional spin cycle.

A version of the reels may include Joker indicia and or a Jackpot indicia to vary the rules of number selection, or indeed sponsor's logos associated for example, with the numeric indicia which can also give rise to further prizes if appearing in predetermined sequences.

It will be appreciated that various modifications can be made without departing from the inventive concept. For example, instead of a micro-community owner having to seek out friends/family to join the micro-community, a listing of members within complete micro-community memberships can be posted at the site. In addition micro-community owners may change their members, for example removing previous ones and recruiting new ones, in particular where it is clear that a particular member is no longer interested in the game. Changes preferably become effective from the next draw.

In order that the lottery if both public and verifiable, the results of a national lottery for example the US or UK national lottery can be used to define the drawn numbers in the first tier game. Of course a lottery having the appropriate format will be required. In the embodiments discussed here it is contemplated that the draw will take place on a weekly basis although it may be held less frequently if it is initially desired to build up a user base, weekly draws only being performed once the user base reaches a pre-select number. In addition the prize money can be increased as participation increases.

Preferably, various levels of registration are offered on entry to the game, which is only required the first time the user logs on. The more information provided in the registration, the more advertisements and promotions at the web site can be targeted to the profile of the user. In a preferred embodiment three profiling registration levels are offered: entry, intermediate and comprehensive level, each level requiring more detailed presentation information about the user. In addition the prize payout can be associated to the profile level, for example registration at entry level will pay out one third of prize money, at intermediate level two thirds, at comprehensive level the full prize. Entry-level players may upgrade their registration level when they become comfortable with the game and company and releasing more information on themselves. However, the targeting can be made optional, for example by registering at entry level and paying a yearly subscription fee to be eligible for the full prize money. On registration, the user is assigned a unique registration number—different from their pool specific serial number and independent of their pool or MC membership—for identification and administrative purposes. The user's registration is only validated once they have joined a micro-community. As a result, the user must participate as a member of a micro-community to be eligible for the rewards available.

Implementation of the system according to the invention will be apparent to the skilled person. Preferably the game software is incorporated as part of an Internet browser (i.e. a Java applet or Java script etc). This can be dynamically downloadable from the server at the time of play, or operated from a PC resident program and linked to a central controlling server. As discussed above the pool games may be user selectable and/or randomly assigned by the central game processor, and the games may be played individually or in teams, for example jointly over the Internet.

The skilled reader will further appreciate that any alternative type of random draw can form the first tier event, and that any appropriate second tier game can be incorporated. In addition winnings can be apportioned amongst micro-community members in any appropriate manner, and indeed the micro-community itself may be optional—instead users will enter the first and second tiers individually. Furthermore, although the preferred embodiment is discussed in terms of an online event system, a ticket based or manual system can be established according to the same principles.

1. A method of maintaining user participation in an event occurring periodically at a site on a computer network, in which a user registers at the site to participate in a first tier event having a user successful or a user unsuccessful outcome, wherein on a user unsuccessful outcome the user is automatically entered for participation in the next first tier event, and on a user successful outcome an automatic invitation is issued from the site for the user to participate in a second tier event.

2. A method as claimed in claim 1 in which the first tier event comprises a random number draw and the user is assigned a pool number on registration, the user successful outcome occurring if the user pool number matches the random number drawn.

3. A method as claimed in claim 2 in which the user is a member of a group of users each assigned different numbers, all of the numbers being compared with the random number draw.

4. A method as claimed in claim 3 in which if all of the user numbers match all of the random number draw, a first tier prize is won.

5. A method as claimed in claim 3 or 4 in which if any of the user numbers match any of the random numbers drawn, the automatic invitation for participation in the second tier event is for the group of users.

6. A method as claimed in any of claims 3 to 5 in which a user can be a member of more than one group, up to a predetermined limit.

7. A method as claimed in any of claims 3 to 6 in which each group of users comprises one group owner and one or more group members.

8. A method as claimed in claim 7 in which first and second tier prizes are available, and the group owner is apportioned a larger share of the prize than each group member.

9. A method as claimed in claim 6 or claim 7 in which a user can only be a group owner for a single group.

10. A method as claimed in any of claims 3 to 9 in which a group must have as many members as members in the random draw to participate to win the first tier event, and must have more than a predetermined lower number of members to qualify for participation in the second tier event.

11. A method as claimed in any preceding claim in which if the automatic invitation is not accepted a predetermined number of times then the user is removed from participation in the next first tier event.

12. A method as claimed in any preceding claim in which the second tier event comprises one or more games having a plurality of user participants in which points are allocated to a user.

13. A method as claimed in claim 12 in which the user allocated the highest points wins a game prize.

14. A method as claimed in any preceding claim in which participants in the second tier event are automatically entered for participation in the next first tier event.

15. A method as claimed in any of claims 12 to 14 in which the user is a member of a group of users participating as a group in the game.

16. A user participation event system comprising a user terminal and an event host, in which a user registers at the host via the terminal to participate in a first tier event having a user successful or a user unsuccessful outcome, wherein on a user unsuccessful outcome the user is automatically entered by the host for participation in the next first tier event, and on a user successful outcome an automatic invitation is issued by the host for the user to participate in a second tier event.

17. A host for a user participation event arranged to receive a user registration, provide a first tier event having a user successful or a user unsuccessful outcome, automatically enter the user for participation in the next first tier event on a user unsuccessful outcome and automatically issue an invitation for the user to participate in a second tier event on a user successful outcome.

18. A computer network site for a user participation event arranged to receive a user registration, provide a first tier event having a user successful or a user unsuccessful outcome, automatically enter the user for participation in the next first tier event on a user unsuccessful outcome and automatically issue an invitation for the user to participate in a second tier event on a user successful outcome.

19. A computer or server programmed to support a site as claimed in claim 18.

20. A game system in which a user registers to participate in a periodically repeated first game, is invited to participate in a second game if the first game outcome is successful, and is re-entered for participation in the next first game if the first game outcome is unsuccessful.

21. A method of enhancing user participation in an event occurring periodically at a site on a computer network, in which a user registers at the site to participate as one of a group of users in a first tier event having a user successful or a user unsuccessful outcome, and on a user successful outcome for any user in the group an automatic invitation is issued from the site for the user to participate in a second tier event.

22. A game system in which a user registers to participate as one of a group of users in a periodically repeated first game, and is invited to participate in a second game if the first game outcome is successful for any user in the group.
